(19) United States
(12) Patent Application Publication
(10) Pub. No.: US 2009/0009584 A1
(43) Pub. Date: Jan. 8, 2009

(54) WIRELESS IMAGE SIGNAL TRANSMISSION DEVICE

(75) Inventors: CHING-HSIANG LEE, TAIPEI (TW); HSIEN-CHUN KAO, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: AZUREWAVE TECHNOLOGIES, INC., TAIPEI (TW)

(21) Appl. No.: 11/773,024

(22) Filed: Jul. 3, 2007

(51) Int. Cl. H04N 7/14; H04N 5/228; H04N 5/335

(52) U.S. Cl. 348/14.02; 348/222.1; 348/294; 348/E07.077; 348/E05.031; 348/E05.091

(57) ABSTRACT

A wireless image signal transmission device includes a wireless receiving and sending unit, an image-obtaining unit, and a control unit. The image-obtaining unit is used for obtaining an image signal. The control unit is electrically connected between the wireless receiving and sending unit and the image-obtaining unit. The control unit includes an image-processing unit, a plurality of first expanding interface units, and a core unit. The core unit is electrically connected with the image-processing unit and the first expanding interface unit so that the image-processing unit processes the image data received by the first expanding interface unit and converts the processed image data into a wireless network signal. Next, the wireless receiving and sending unit transmits the wireless network signal to the application system. Thereby, it is easy to integrate the system and can be applied to a variety of application fields.

### BACKGROUND OF THE INVENTION

1. Field of the Invention

The present invention relates to an image signal transmission device. In particular, this invention relates to an image signal transmission device that uses a wireless network to transmit data.

2. Description of the Related Art

Because computers provide a variety of functions, including multimedia functions, computers can easily process image data. The processed image data makes the image attractive and users often wish to transmit the image data to another person via the Internet. Thereby, video conferencing, image and video email, video education, household security and video telephony via the Internet have also been developed, while PC cameras have also become popular.

A PC camera is usually connected with a computer via a wired method (such as a USB). Because a wire needs to be connected with the computer, the PC camera can only be located near the computer. It is inconvenient for the user, and the function of the PC camera is limited.

In order to overcome this problem, a network camera has been developed that combines the PC camera with a wireless network module. The network camera can be controlled or operated via the Internet. Reference is made to FIG. 1, which shows a block diagram of the wireless camera of the prior art. The wireless camera 9 includes a wireless network module 91 and an image-processing module 92. The wireless network module 91 is used for processing the wireless network transmission, and includes a wireless network control unit 911 and a wireless receiving and sending unit 912. The wireless network control unit 911 is connected with and controls the wireless receiving and sending unit 912. An antenna 913 is used for receiving and sending the wireless data with a connected application system. The image-processing module 92 includes a microprocessor 921 and an image-obtaining unit 922 so that the microprocessor 921 can process the image data obtained by the image-obtaining unit 922. Finally, the wireless network control unit 911 cooperates with the microprocessor 921 to control the conversion and transmission of data between both. Thereby, the wireless network module 91 communicates with the image-processing module 92 and the function of the wireless camera 9 implemented.

However, from FIG. 1, the wireless camera 9 includes at least two modules so that the wireless camera takes up a large amount of space and cannot be applied to a variety of application fields. Furthermore, the wireless network module 91 and the image-processing module 92 belong to two different technology fields. It is difficult to integrate the wireless network module 91 and the image-processing module 92. Therefore, the functions of the wireless camera cannot be easily expanded.

### SUMMARY OF THE INVENTION

One particular aspect of the present invention is to provide a wireless image signal transmission device. It uses a system on chip to integrate the wireless network function with the image-processing function. It is designed with different bus interfaces and control interfaces to expand its functions. Thereby, the image processing function and the transmission function are integrated together, and the wireless image signal transmission device can be easily applied to a variety of application fields. It is easy to expand its functions or connect a function module via the bus interfaces and the control interfaces. The wireless image signal transmission device is versatile.

The wireless image signal transmission device includes a wireless receiving and sending unit, an image-obtaining unit, and a control unit. The wireless receiving and sending unit is used for connecting an application system via a wireless transmission method. The image-obtaining unit is used for obtaining an image signal. The control unit is electrically connected between the wireless receiving and sending unit and an image-obtaining unit. The control unit includes an image-processing unit, a plurality of first expanding interface units, and a core unit. One of the first expanding interface units is electrically connected with the image-obtaining unit for transmitting the image data. The core unit is electrically connected with the image-processing unit and the first expanding interface unit so that the image-processing unit processes the received image data, and converts the processed image data into a wireless network signal. Next, the wireless receiving and sending unit transmits the wireless network signal to the application system. Thereby, it is easy to be applied to a variety of application fields. Furthermore, because the control unit has a plurality of expanding interface units with different formats, the functions of the wireless image signal transmission device are easily expanded.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the wireless camera of the prior art;

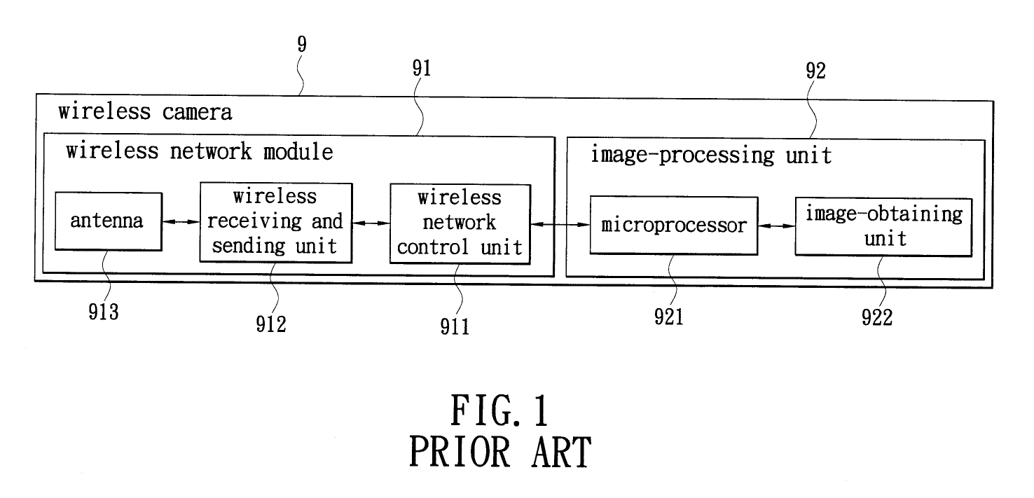

FIG. 2 is a schematic diagram of the embodiment of the present invention; and

FIG. 3 is a block diagram of the wireless image signal transmission device of the embodiment of the present invention.

### DETAILED DESCRIPTION OF THE PREFERRED EMBODIMENTS

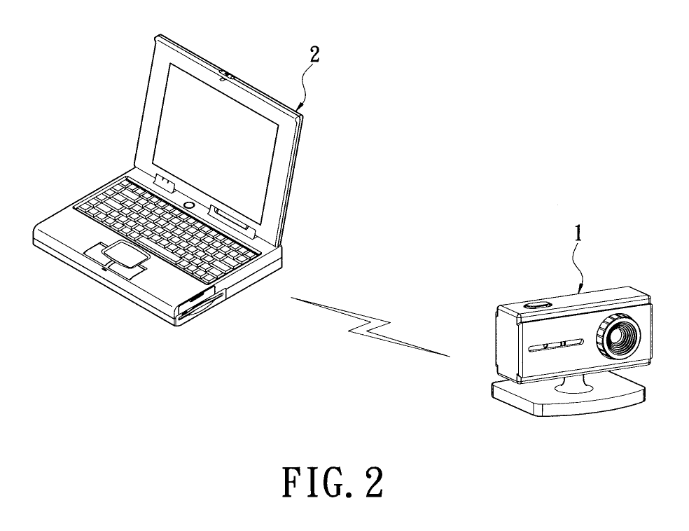

Reference is made to FIG. 2, which shows a schematic diagram of the embodiment of the present invention. The wireless image signal transmission device 1 can obtain an image data and transmits the image data to an application system 2 via a wireless network. When the application system 2 used by the user has the wireless network function, the application system 2 can be connected with the wireless image signal transmission device 1 in a wireless manner to receive the image data of the wireless image signal transmission device 1.

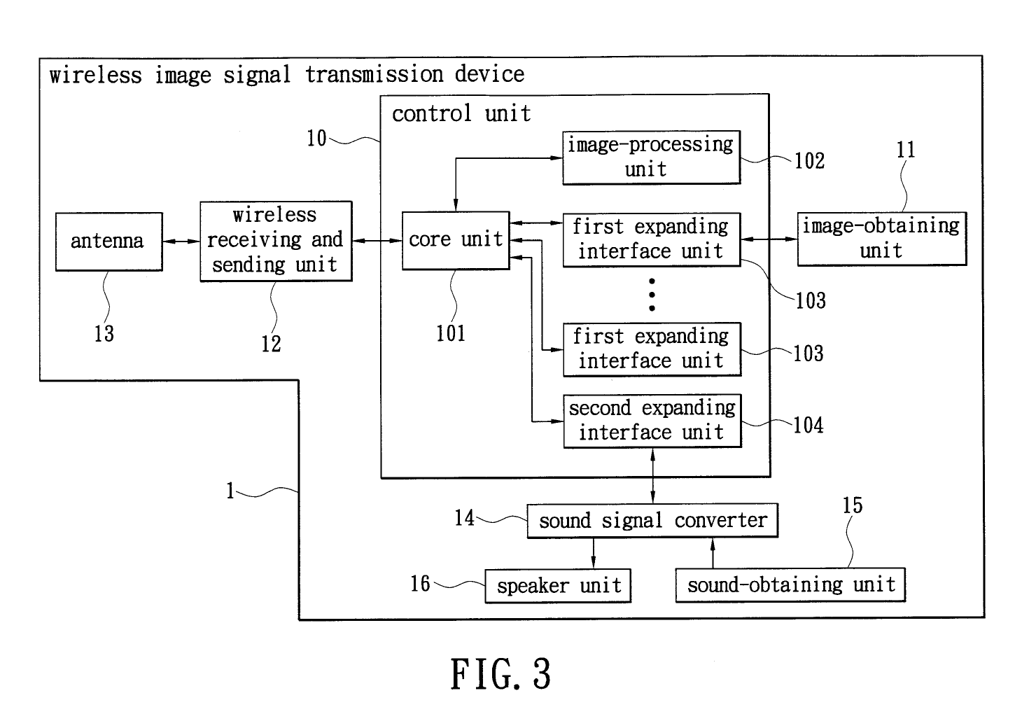

Reference is made to FIG. 3, which shows a block diagram of the wireless image signal transmission device of the embodiment of the present invention. The wireless image signal transmission device 1 includes a control unit 10, an image-obtaining unit 11, a wireless receiving and sending unit 12, and an antenna 13. The wireless receiving and sending unit 12 is a RF-baseband transceiver, and is electrically connected with the antenna 13. Therefore, the control unit 10 can control the wireless receiving and sending unit 12, and is connected with the application system 2 in a wireless manner via the antenna 13.

The image-obtaining unit 11 is a CCD or a CMOS digital image-obtaining unit for obtaining an image signal at the location of the wireless image signal transmission device 1.

The control unit 10 is electrically connected between the image-obtaining unit 11 and the wireless receiving and sending unit 12. The control unit 10 includes a core unit 101, an image-processing unit 102, a plurality of first expanding interface units 103, and at least one second expanding interface unit 104. One of the first expanding interface units 103 is electrically connected with the image-obtaining unit 11 for receiving and transmitting the image data obtained by the image-obtaining unit 11.

The core unit 101 located in the control unit 10 is a core processing unit for processing wireless network functions. The core unit 101 is electrically connected with the image-processing unit 102, the first expanding interface unit 102, and the second expanding interface unit 104. When the core unit 101 receives the image data via the first expanding interface unit 10, the core unit 101 enables the image-processing unit 102 to process and encode the image data. Next, the core unit 101 converts the image data processed by the image-processing unit 102 into a wireless network signal. Finally, the control unit 10 controls the wireless receiving and sending unit 12 and transmits the wireless network signal to the application system 2 via the antenna 13.

In this embodiment, the first expanding interface unit 103 can be a USB, an SPI, a UART, a GPIO or a BT656 cooperating with an 12C. Therefore, by using the first expanding interface unit 103 to connect to the image-obtaining unit 11, the user can obtain the image signal, and performs an active control at the application system 2 to output an operating signal. The operating signal is transmitted to the wireless image signal transmission device 1 via the same wireless network. The control unit 10 in the wireless image signal transmission device 1 controls the operation of the image-obtaining unit 11 via the first expanding interface unit 103 according to the operating signal (such as zooming or changing the focus direction). Thereby, the wireless image signal transmission device 1 can transmit data in two directions.

As described as above, the control unit 10 in the wireless image signal transmission device 1 also includes a second expanding interface unit 104. The second expanding interface unit 104 is an I2S. Therefore, the wireless image signal transmission device 1 can be further installed with a sound signal converter 14, a sound-obtaining unit 15, and a speaker unit 16. The second expanding interface unit 104 is electrically connected with the sound signal converter 14 so that the control unit 10 controls the sound signal converter 14 via the second expanding interface unit 104. Thereby, the wireless image signal transmission device 1 can transmit sounds.

The sound-obtaining unit 15 is a microphone for receiving a sound signal of the location of the wireless image signal transmission device 1. The speaker unit 16 is a horn for outputting an analog sound signal. Furthermore, the sound signal converter 14 includes an analog-to-digital converter (ADC) and a digital-to-analog converter (not shown in the figure) that are respectively connected with the sound-obtaining unit 15 and the speaker unit 16.

When the sound-obtaining unit 15 receives the sound signal, the analog-to-digital converter in the sound signal converter 14 receives the sound signal and converts the analog sound signal into a digital sound signal. The digital sound signal is transmitted to the core unit 101 via the second expanding interface unit 104. The control unit 10 transmits a wireless signal to the application system 2 via the wireless receiving and sending unit 12. When the user generates a digital sound signal at the application system 2 and transmits a wireless signal to the control unit 10 of the wireless image signal transmission device 1, the control unit 10 outputs the digital sound signal to the sound signal converter 14 via the second expanding interface unit 104. The digital-to-analog converter in the sound signal converter 14 converts the digital sound signal into an analog sound signal, and the analog sound signal is outputted from the speaker unit 16.

The present invention uses a system on chip to integrate the image-processing function in the control chip of a wireless network. The image signal transmission device is integrated, and the wireless image signal transmission device can be easily applied to a variety of application fields. By providing a variety of expanding interface units (such as USB, SPI, I2S, etc.), it is easy to expand its functions via the expanding interface units. For example, the wireless image signal transmission device is connected with a storage medium via a USB, thereby adding a data storage function.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A wireless image signal transmission device, performing a wireless transmission with an application system, comprising:
a wireless receiving and sending unit for receiving and sending signals with the application system;
an image-obtaining unit for obtaining an image signal; and
a control unit electrically connected between the wireless receiving and sending unit and an image-obtaining unit, wherein the control unit further comprises:
an image-processing unit for processing the image signal;
a plurality of first expanding interface units, wherein one of the first expanding interface units is electrically connected with the image-obtaining unit for transmitting the image signal; and
a core unit electrically connected the image-processing unit and the first expanding interface unit so that the image-processing unit processes the received image data and converts the processed image data into a wireless network signal, and the wireless receiving and sending unit transmits the wireless network signal to the application system.

2. The wireless image signal transmission device as claimed in claim 1, wherein the image-obtaining unit is a CCD or a CMOS digital image-obtaining unit.

3. The wireless image signal transmission device as claimed in claim 1, wherein the control unit receives an operating signal outputted from the application system, and controls the image-obtaining unit via the first expanding interface unit according to the operating signal.

4. The wireless image signal transmission device as claimed in claim 1, wherein the first expanding interface unit is a USB, an SPI, an UART, a GPIO, or a BT656 cooperating with an I2C.

5. The wireless image signal transmission device as claimed in claim 1, further comprising an antenna electrically connected with the wireless receiving and sending unit so that the wireless receiving and sending unit is connected with the application system in a wireless manner via the antenna.

6. The wireless image signal transmission device as claimed in claim 1, further comprising:
a sound-obtaining unit for receiving a sound signal;
a speaker unit for outputting an analog sound signal; and
a sound signal converter electrically connected between the sound-obtaining unit, the speaker unit and the control unit for receiving the sound signal, converting the analog sound signal into a digital sound signal and transmitting the digital sound signal to the control unit, and receiving a digital sound signal from the control unit and converting the digital sound signal into an analog sound signal.

7. The wireless image signal transmission device as claimed in claim 6, wherein the digital sound signal is transmitted to the control unit from the application system via the wireless transmission.

8. The wireless image signal transmission device as claimed in claim 6, wherein the control unit further comprises a second expanding interface unit for connecting the sound signal converter.

9. The wireless image signal transmission device as claimed in claim 8, wherein the second expanding interface unit is an I2S.
